(19) United States
(12) Patent Application Publication
(10) Pub. No.: US 2008/0155313 A1
(43) Pub. Date: Jun. 26, 2008

(54) SEMICONDUCTOR MEMORY DEVICE AND METHOD

(75) Inventors: Florian Schamberger, Bad Reichenhall (DE); Ralf Schneider, Muenchen (DE)

Correspondence Address: DICKE, BILLIG & CZAJA, FIFTH STREET TOWERS, 100 SOUTH FIFTH STREET, SUITE 2250, MINNEAPOLIS, MN, 55402, US

(73) Assignee: QIMONDA AG, Muenchen (DE)

(21) Appl. No.: 11/958,976

(22) Filed: Dec. 18, 2007

(30) Foreign Application Priority Data
Dec. 18, 2006 (DE) 10 2006 059 744.3

(51) Int. Cl. G06F 11/00

(52) U.S. Cl. 714/6; 714/E11.001

(57) ABSTRACT

A semiconductor memory device with redundant memory cells and a method for operating a semiconductor memory device is disclosed. One embodiment provides at least one memory cell and at least one redundant memory cell. The method includes reading out data written in the memory cell; determining whether the read-out data concur with target data; reprogramming or reconfiguring, respectively, the semiconductor device, so that the redundant memory cell replaces the memory cell if the read-out data do not concur with the target data; and writing the target data in the redundant memory cell already during the reprogramming or reconfiguring, respectively.

### CROSS-REFERENCE TO RELATED APPLICATIONS

This Utility Patent Application claims priority to German Patent Application No. DE 10 2006 059 744.3 filed on Dec. 18, 2007, which is incorporated herein by reference.

### BACKGROUND

The invention relates to a method for operating a semiconductor memory device, and to a semiconductor memory device with redundant memory cells.

In the case of semiconductor memory devices, one differentiates between functional memory devices (e.g., PLAs, PALs, etc.), and table memory devices, e.g., ROM devices (ROM=Read Only Memory), and RAM devices (RAM=Random Access Memory or write-read memory).

A RAM device is a memory for storing data under a predetermined address and for reading out the data again under this address later.

The corresponding address may be input in the RAM device via address connections or address input pins. For the input and output of the data, a plurality of, e.g., 16, data connections or data input/output pins (I/Os or Inputs/Outputs) are provided. By applying an appropriate signal (e.g., a read/write signal) to a write/read selection pin it may be selected whether (presently) data are to be stored or to be read out.

Since as many memory cells as possible are to be accommodated in a RAM device, one has been trying to realize them as simple as possible. In the case of SRAMs (SRAM=Static Random Access Memory), the individual memory cells consist e.g., of few, for instance 6, transistors, and in the case of DRAMs (DRAM=Dynamic Random Access Memory) in general only of one single, correspondingly controlled capacitor with the capacitance of which one respective bit can be stored as charge. This charge, however, remains for a short time only. Therefore, a “refresh” must be performed regularly, e.g., approximately every 64 ms.

For technological reasons, in the case of memory devices, in one embodiment DRAM devices, the individual memory cells are—positioned side by side in a plurality of rows and columns—arranged in a rectangular matrix or a rectangular array, respectively.

To achieve a high total storage capacity, and/or to achieve a data read or write rate that is as high as possible, instead of one single array, a plurality of, e.g., four —substantially rectangular—individual arrays (so-called “memory banks”) may be provided in an individual RAM device or chip (“multi-bank chip”).

In order to perform a write or read access, a particular, predetermined succession of instructions has to be run through:

For instance, by using a word line activate instruction (activate instruction (ACT)), a corresponding word line—that is assigned to a particular single array (“memory bank”)—(and that is, for instance, defined by the row address) is first of all activated.

Subsequently—by using a corresponding read or write instruction (read (RD) or write (WT) instruction)—it is initiated that the corresponding data—that are then exactly specified by the corresponding column address—are correspondingly output (or read in).

Next—by a word line deactivate instruction (e.g., a precharge instruction (PRE instruction))—the corresponding word line is deactivated again, and the corresponding array (“memory bank”) is prepared for the next word line activate instruction (activate instruction (ACT)).

To increase the productivity of a corresponding DRAM device, a corresponding memory device controller (“memory controller”) may—after outputting a corresponding word line activate instruction (ACT instruction) and a corresponding read (or write) instruction (RD (or WT) instruction)—leave the respective word line first of all in an activated state (i.e. the corresponding word line deactivate instruction (PRE instruction) may first of all be suppressed).

If then—which is, from a statistic point of view, the case relatively frequently—in the corresponding array (“memory bank”) (a) memory cell(s) is/are accessed next which is/are assigned to the same word line or row, respectively, as the memory cell(s) which was/were accessed last, the outputting of a further word line activate instruction (ACT instruction) may be waived.

Instead, the memory device controller (“memory controller”) may directly output a corresponding read (or write) instruction (RD (or WT) instruction) to the respective array (“memory bank”) (and it may thus be achieved that the corresponding data are immediately read out (or input, respectively)).

Conventional memory devices may—in addition to the above-mentioned memory cells arranged in the above-mentioned arrays—include a plurality of further, redundant memory cells, and a “self repair circuit”.

During the test operation of a corresponding memory device, corresponding predefined or random-generated test data may—e.g., in the manner explained in more detail above—be stored successively in the memory cells of the respective memory device, and subsequently be read out again, and the stored data or the data—actually—to be stored (“target data”) may be compared with the read-out data (“actual data”).

If an error is detected—i.e. if the stored data or the data to be stored do not concur with the read-out data—a reprogramming is performed for the corresponding—defect—memory cell by the self-repair circuit.

In a future write or read access to the defective memory cell, a corresponding redundant memory cell will then be accessed instead of the defective memory cell.

This memory cell is, however, first of all in a non-initialized state.

Prior to the continuation of the above-mentioned test operation—for initialization of the redundant memory cell—corresponding test data must thus again be stored in the respective memory device—in one embodiment in the redundant memory cell replacing the above-mentioned defective memory cell.

This results in a relatively long delay of the test operation.

For these and other reasons, there is a need for the present invention.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates a schematic representation of the structure of a semiconductor memory device including a plurality of arrays, redundant memory cells, and a self-repair circuit in accordance with one embodiment, and of a memory device controller.

FIG. 2 illustrates a schematic representation of the semiconductor memory device illustrated in FIG. 1, and of a test device by using which a semiconductor device test method in accordance with one embodiment may be performed.

FIG. 3a illustrates a schematic representation of the temporal occurrence of several phases of the semiconductor device test method in accordance with a first variant.

FIG. 3b illustrates a schematic representation of the temporal occurrence of several phases of the semiconductor device test method in accordance with a second variant.

FIG. 3c illustrates a schematic representation of the temporal occurrence of several phases of the semiconductor device test method in accordance with a third variant.

FIG. 3d illustrates a schematic representation of the temporal occurrence of several phases of the semiconductor device test method in accordance with a fourth variant.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that the features of the various exemplary embodiments described herein may be combined with each other, unless specifically noted otherwise.

One embodiment provides a method for the operation of a semiconductor memory device, and a semiconductor memory device with redundant memory cells.

In accordance with one embodiment there is provided a method for operating a semiconductor memory device including at least one memory cell and at least one redundant memory cell that is equipped such that it is adapted to replace the memory cell.

The method includes:

reading out data that are written in the memory cell;

determining whether the read-out data concur with target data;

reprogramming or reconfiguring, respectively, the semiconductor device, so that the redundant memory cell replaces the memory cell if the read-out data do not concur with the target data; and

writing the target data in the redundant memory cell already during the reprogramming or reconfiguring, respectively.

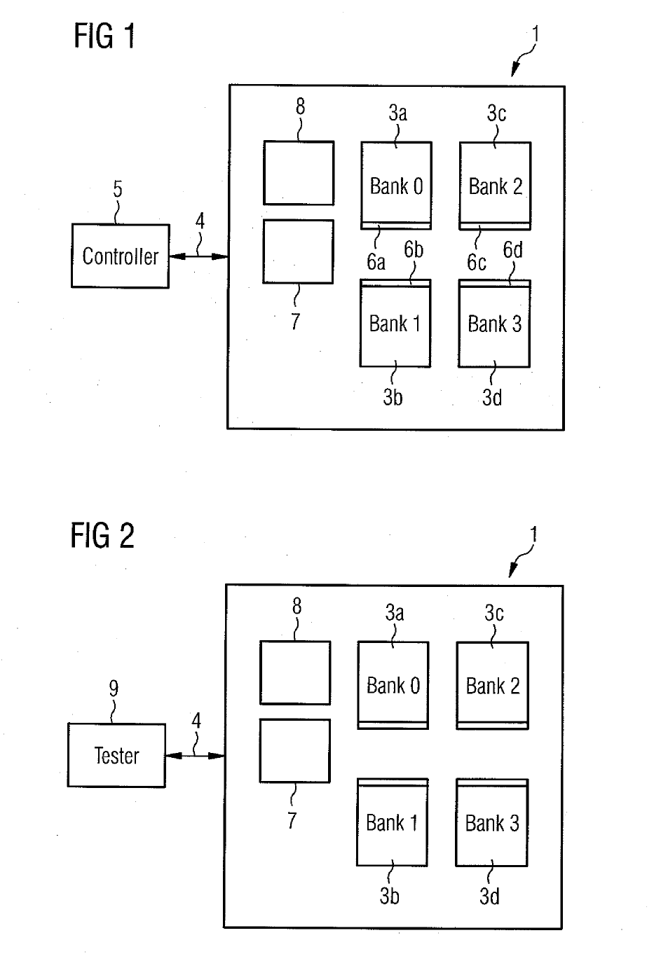

FIG. 1 illustrates a schematic representation of the structure of a semiconductor memory device 1 or semiconductor memory chip, respectively, and of a—central—memory device controller 5 (“memory controller”) in accordance with one embodiment.

The semiconductor memory device 1 may, for instance, be a table memory device—that is, for instance, based on CMOS technology —, e.g., a RAM memory device (RAM=Random Access Memory or write-read memory), in one embodiment a DRAM memory device (DRAM=Dynamic Random Access Memory or dynamic write-read memory).

In the semiconductor memory device 1—after the input of a corresponding address (e.g., by the memory device controller 5)—data may be stored under the respective address and be read out again under this address later.

The address may be input in several, e.g., two successive steps (e.g., first of all a row address—and possibly parts of a column address) (and/or possibly further address parts, or parts thereof)—and then the column address (or the remaining parts of the column address), and/or—only now—the above-mentioned further address parts (or the remaining parts thereof), etc.).

By applying a corresponding control signal (e.g., a read/write signal)—e.g., by the memory controller 5—it may be selected whether data are to be stored or to be read out.

The data input in the semiconductor memory device 1 are, as will be explained in more detail in the following—stored in corresponding memory cells there, and are read out again from the corresponding memory cells later.

Each memory cell consists, for instance, of few elements, in one embodiment only of one single, correspondingly controlled capacitor with the capacitance of which one respective bit can be stored as charge.

As results from FIG. 1, a particular number of memory cells—each positioned side by side in a plurality of rows and columns—may each be arranged to be positioned in a rectangular or square array (“memory bank”) 3a, 3b, 3c, 3d, so that—in correspondence with the number of memory cells contained—e.g., 32 MBit, 64 MBit, 128 MBit, 256 MBit, 512 MBit, 1 GBit, etc. may be stored in an array 3a, 3b, 3c, 3d.

As is further illustrated in FIG. 1, the semiconductor memory device 1 includes a plurality of, e.g., four, substantially identically structured memory cell arrays 3a, 3b, 3c, 3d (here: the memory banks 0-3), which are distributed evenly over the area of the device and are, for instance, controlled by the above-mentioned memory controller 5 substantially independently of each other, so that a total storage capacitance of e.g., 128 MBit, 256 MBit, 512 MBit, 1 GBit, 2 GBit, 4 GBit, etc. correspondingly results for the semiconductor memory device 1.

By providing several, substantially independent arrays 3a, 3b, 3c, 3d, it can be achieved that—in parallel or temporally overlapping—corresponding write or read accesses may be performed in several, different arrays 3a, 3b, 3c, 3d.

The above-mentioned address (input in the semiconductor memory device 1 or the memory device controller 5, respectively) may—as a part of the above-mentioned further address parts—e.g., include a corresponding number of (here e.g., two) bits (“array select bits” or “bank address bits”) serving to address the respectively desired array 3a, 3b, 3c, 3d during the storing or reading out of data.

The above-mentioned—central—memory device controller 5 (“memory controller”) may—as is illustrated by way of example in FIG. 1—be designed as a separate semiconductor device communicating with the semiconductor device 1 via external pins (i.e. as a separate chip).

In one embodiment, the memory device controller 5 may, for instance, also be arranged on one and the same chip 1 as the above-mentioned memory cell arrays 3a, 3b, 3c, 3d (memory banks 0-3).

As results from FIG. 1, each array 3a, 3b, 3c, 3d may include an array controller 6a, 6b, 6c, 6d that is separately assigned to the respective array 3a, 3b, 3c, 3d; a central controller (not illustrated here)—controlling all arrays 3a, 3b, 3c, 3d centrally—may be provided on the semiconductor memory device 1, wherein corresponding control tasks may, for instance, partially be assumed by the central controller, and partially by the array controllers 6a, 6b, 6c, 6d.

To perform a write or read access, a particular, predetermined, specific sequence of instructions may be run through in the embodiment illustrated here:

For instance, first of all, by using a word line activate instruction (activate instruction (ACT)), a corresponding word line—that is, in one embodiment, assigned to a particular single array 3a, 3b, 3c, 3d (memory bank 0-3)—(and that is, for instance, defined by the above-mentioned row address) is activated.

This happens, for instance, in that—as is illustrated in FIG. 1-a corresponding word line activate instruction signal (ACT signal) is—by the memory device controller 5 via one or a plurality of control lines of a corresponding control line data bus 4—sent to the semiconductor memory device 1 (and—e.g., simultaneously—the above-mentioned address).

In reaction to the receipt of the above-mentioned word line activate instruction signal (ACT signal), the above-mentioned array controller 6a, 6b, 6c, 6d or the above-mentioned central controller, respectively, initiates that the data values stored in the respective row of the respective array—which is defined by the respective row address—are read out by the sense amplifiers assigned to the respective word line (“activated state” of the word line).

Subsequently—by a corresponding read or write instruction ((RD) or (WT) instruction)—it is initiated that the corresponding data—which are then exactly specified by the corresponding column address—are output (or read in) correspondingly.

To this end, after the above-mentioned word line activate instruction signal (ACT signal), a corresponding read or write instruction signal ((RD) or (WT) instruction) signal) may be sent from the memory device controller 5 via corresponding control lines of the above-mentioned control line data bus 4 to the semiconductor memory device 1 (and—e.g., simultaneously—the above-mentioned column address).

Next—by a word line deactivate instruction (e.g., a precharge instruction (PRE instruction))—the corresponding word line may again be deactivated, and the corresponding array 3a, 3b, 3c, 3d (memory bank 0-3) may be prepared for the next word line activate instruction (activate instruction (ACT)).

As is schematically illustrated in FIG. 1, the semiconductor memory device 1 includes—in addition to the above-mentioned memory cells arranged in the arrays 3a, 3b, 3c, 3d—a plurality of further redundant memory cells that are arranged in a corresponding memory redundancy area 8, and a self repair circuit 7.

Instead of the memory redundancy area 8 that is schematically illustrated in FIG. 1, a plurality of memory redundancy areas may also be provided, which may, for instance, each be individually assigned to the respective arrays 3a, 3b, 3c, 3d.

As is illustrated in FIG. 2, the semiconductor memory device 1 may, for performing a semiconductor device test in accordance with an embodiment of the present invention, be placed from a normal mode of operation to a test mode of operation.

To this end—e.g., via the above-mentioned control line data bus 4 or a data bus corresponding thereto—corresponding mode change instruction data (e.g., a test pattern characterizing the corresponding test mode of operation—may be applied to the semiconductor memory device 1 by a test device 9 that is connected to the data bus 4.

Subsequently, corresponding predefined test data (e.g., test data that have been stored in advance in the test device 9 (or in one embodiment e.g., in the self repair circuit 7, or in any further device), or test data that have been random-generated—e.g., by using a random generator or a random pattern generator in the test device 9 (or in one embodiment in the self repair circuit 7, or the above-mentioned further device, etc.), in one embodiment corresponding test pattern data, may be stored successively in the memory cells of the arrays 3a, 3b, 3c, 3d of the semiconductor memory device 1.

To this end, in a first variant of the present embodiment—correspondingly similar as described above for the normal mode of operation—a corresponding write access to the semiconductor device 1 may be performed by the test device 9, and thus the test data or test pattern data stored/generated in the test device 9 may be stored in memory cells—which are assigned to corresponding row and column addresses—of the arrays 3a, 3b, 3c, 3d of the semiconductor device 1.

The row and column addresses may be generated in the test device 9 (or in one embodiment, for instance, in the self repair circuit 7, or in the above-mentioned further device), e.g., such that successively all the memory cells assigned to one and the same row of an array 3a, 3b, 3c, 3d are initially written with corresponding test data, subsequently all the memory cells assigned to a proximate cell, etc. In one embodiment, the row and column addresses to be used may also be generated in any other manner, e.g., by using an appropriate random generator or random pattern generator, etc.

For storing the test data in the semiconductor memory device 1, the sequence of instructions which is explained in more detail above may be run through (or a correspondingly similar sequence of instructions):

For instance, initially, by using a word line activate instruction (activate instruction (ACT)), a corresponding word line—that is, in one embodiment, assigned to a particular single array 3a, 3b, 3c, 3d (memory bank 0-3)—(and that is, for instance, defined by the above-mentioned row address) is activated.

This happens, for instance, in that—as is illustrated in FIG. 2-a corresponding word line activate instruction signal (ACT signal) is sent, by the test device 9 via the above-mentioned control line data bus 4, to the semiconductor memory device 1 (and—e.g., simultaneously—to the above-mentioned (row) address).

Subsequently—by using a corresponding write instruction (WT instruction)—it is initiated that the corresponding test data are then stored in the memory cells that are then exactly specified by the corresponding column address.

To this end, after the above-mentioned word line activate instruction signal (ACT signal), a corresponding write instruction signal (WT instruction signal) may be sent, by the test device 9 via the above-mentioned control line data bus 4, to the semiconductor memory device 1 (and—e.g., simultaneously—to the above-mentioned column address).

Other than in the above-mentioned normal mode of operation, in the test mode of operation, the above-mentioned test data can, by the above-mentioned or a correspondingly similar instruction sequence, not only be stored in the memory cells of the arrays 3a, 3b, 3c, 3d of the semiconductor memory device 1, but—simultaneously—additionally also in the self repair circuit 7 (or in corresponding registers provided there).

In one embodiment, the above-mentioned or a correspondingly similar write access may, instead of being performed under control of the test device 9, e.g., also be performed under control of the self repair circuit 7 (or in any other manner, e.g., by the above-mentioned further device), and thus the above-mentioned test data or test pattern data may be stored in memory cells of the arrays 3a, 3b, 3c, 3d of the semiconductor memory device 1 which are assigned to corresponding row and column addresses.

Subsequently, the test data stored in the memory cells of the arrays 3a, 3b, 3c, 3d of the semiconductor memory device 1 are read out again, and the stored data or the data—actually—to be stored (“target data”) are compared with the read-out data (“actual data”).

The reading out of the test data from the memory cells that are assigned to corresponding row and column addresses may, for instance—again—be performed under control of the test device 9 (in that a corresponding read access is performed), or, for instance, in one embodiment also under control of the self repair circuit 7 (or in any other manner, e.g., by the above-mentioned further device).

For reading out the test data, the sequence of instructions that is explained in more detail above may, for instance—again—be run through (or a correspondingly similar instruction sequence):

For instance—if the corresponding word line has not yet been activated (see below)—the corresponding word line—which is, in one embodiment, assigned to a particular single array 3a, 3b, 3c, 3d (memory bank 0-3)—(and which is, for instance, defined by the above-mentioned row address) is initially activated by using a word line activate instruction (activate instruction (ACT)).

This happens, for instance, in that—as is illustrated in FIG. 2-a corresponding word line activate instruction signal (ACT signal) is sent, by the test device 9 via the above-mentioned control line data bus 4, to the semiconductor memory device 1 (and—e.g., simultaneously—to the above-mentioned (row) address).

Subsequently—by a corresponding read instruction (RD instruction)—it is initiated that the corresponding test data are then read out from the memory cells which are then exactly specified by the corresponding column address.

To this end, after the above-mentioned word line activate instruction signal (ACT signal), a corresponding read instruction signal (RD instruction signal) may be sent, by the test device 9 via the above-mentioned control line data bus 4, to the semiconductor memory device 1 (and—e.g., simultaneously—to the above-mentioned column address).

If the above-mentioned word line or row is still in an activated state, the outputting of the above-mentioned word line activate instruction (ACT instruction) may be waived.

Instead, the test device 9 may then directly output a corresponding read instruction (RD instruction) (and it may thus be achieved that the corresponding test data are read out immediately).

Other than in the above-mentioned normal mode of operation, in the test mode of operation of the semiconductor memory device 1, the above-mentioned test data—that are read out in reaction to the above-mentioned read access—cannot (or not just) be output at corresponding data input/output pins of the semiconductor memory device 1, but may (additionally) be supplied to the above-mentioned self repair circuit 7 that is provided on the semiconductor memory device 1 (or in one embodiment, for instance, to the above-mentioned further device, etc.).

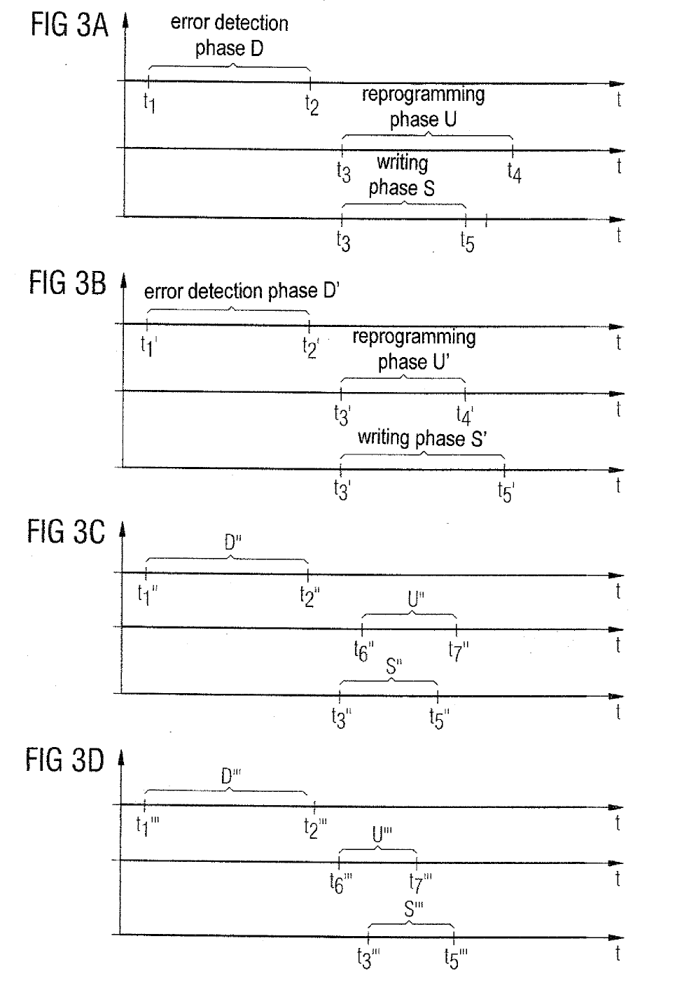

The test data (“actual data”) read out in reaction to the read access are compared in the self repair circuit 7 (or in one embodiment in the above-mentioned further device, or in the test device 9, etc.) with the data that have been stored there before—e.g., in reaction to the above-mentioned write access—(e.g., with the data stored in the above-mentioned registers of the self repair circuit 7), or with the above-mentioned predefined or random—generated test pattern data (“actual data”) (cf. also the “error detection phase” D illustrated in FIG. 3a and lasting, for instance, from a point in time t1 to a point in time t2).

If an error is detected—i.e. if the stored data or the data (actually) to be stored (“target data”) do not concur with the read-out data (“actual data”)—the self repair circuit 7 (or in one embodiment, for instance, the above-mentioned further device (or the test device 9), etc.) performs a reprogramming for the corresponding—defective—memory cell (such that, in a future write or read access to the defective memory cell, a corresponding redundant memory cell is accessed instead of the defective memory cell) (cf. also the “reprogramming phase” U illustrated in FIG. 3a and lasting, for instance, from a point in time t3 to a point in time t4).

Simultaneously, or still in the course of reprogramming (or shortly before or shortly afterwards), the—correct—(test) data (“target data”) that are, for instance, stored in the above-mentioned registers of the self repair circuit 7 are written into the corresponding—redundant—memory cell (cf. also the “write phase” S illustrated in FIG. 3a and lasting, for instance, from a point in time t3 to a point in time t5).

As is illustrated schematically by way of example in FIGS. 3a to 3d, the write phase and the reprogramming phase may overlap completely or partially.

For instance, as is illustrated by way of example in FIG. 3a, the above-mentioned write phase S may substantially start at the same time as the above-mentioned reprogramming phase U (namely at the above-mentioned point in time t3).

In one embodiment, as is, for instance, illustrated by way of example in FIG. 3c, the write phase (there: the write phase S″) may also start somewhat earlier than the reprogramming phase (there: the reprogramming phase U″), e.g., the write phase S″ at a point in time t3″, and the reprogramming phase U″ at a point in time t6″—being shortly after the point in time t3″.

In one embodiment, as is, for instance, illustrated by way of example in FIG. 3d, the write phase (there: the write phase S′″) may also start somewhat later than the reprogramming phase (there: the reprogramming phase U′″), e.g., the reprogramming phase U′″ at a point in time t6′″, and the write phase S′″ at a point in time t3′″—being shortly after the point in time t6′″ (e.g., one or two clocks after a clock of a clock signal controlling the beginning of the reprogramming and write phases, the clock triggering the beginning of the reprogramming phase U′″.

Furthermore, as is, for instance, illustrated by way of example in FIG. 3a (and, for instance, also in FIG. 3c), the above-mentioned write phase S may end somewhat earlier than the reprogramming phase U, e.g., the write phase S (or S″) at a point in time t5 (or t5″), and the reprogramming phase U (or U″) at a point in time t4—being shortly after the point in time t5—(or t7″).

In one embodiment as is, for instance, illustrated by way of example in FIG. 3b (and, for instance, also in FIG. 3d) the write phase S′ may also end somewhat later than the reprogramming phase U′, e.g., the write phase S′ at a point in time t5′, and the reprogramming phase U′ at a point in time t4′—being shortly before the point in time t5′.

In one embodiment, the write and reprogramming phases may, for instance, also be terminated simultaneously or substantially simultaneously.

At the beginning of the reprogramming phase—e.g., at the points in time t3, t3′, t6″, t6′″ illustrated in FIGS. 3a-3d—the data (or parts thereof) required for reprogramming may be sent by the self repair circuit 7 (or in one embodiment by the above-mentioned further device (or the test device 9, etc.)) to a corresponding address decoder circuit provided on the memory device 1, which may, for instance, be part of the above-mentioned array controller 6a, 6b, 6c, 6d, or part of the above-mentioned central controller that is additionally provided on the semiconductor memory device 1.

The data sent to the address decoder circuit may, for instance, include the address (row and/or column address) of the memory cell detected as defective (and/or, for instance, information concerning the array 3a, 3b, 3c, 3d in which the defective memory cell is arranged, etc.), and/or the address of the redundant memory cell that is to be used in the future instead of the defective memory cell and that is, for instance, arranged in the above-mentioned memory redundancy area 8 (and/or, for instance, information that indicates in which of a plurality of different memory redundancy areas the respective redundant memory cell is arranged, etc.).

The address decoder circuit then sees to it that, in the case of a future write or read access to the defective memory cell—in one embodiment in the case of a write or read access taking place after the end of the reprogramming phase U, i.e. after the points in time t4, t4′, t7″, t7′″ illustrated in FIGS. 3a-3c—the corresponding redundant memory cell is then accessed instead of the defective memory cell (e.g., in that, after the input of a row and/or column address assigned to the defective memory cell in the semiconductor memory device 1, the corresponding address or parts thereof is/are converted to the address assigned to the corresponding redundant memory cell).

As has already been explained above, simultaneously with the above-mentioned reprogramming, or still in the course of the corresponding reprogramming phase U (or shortly before or shortly afterwards), the—correct—(test) data (“target data”) (which are actually to be stored in the defective memory cell) which are, for instance, stored in the above-mentioned registers of the self repair circuit 7 are written into the corresponding—redundant—memory cell (“write phase” S).

The data required for writing the above-mentioned—correct—(test) data (“target data”), or parts thereof (e.g., corresponding address and/or control data, and/or the (test) data themselves, etc.) may, for instance, be provided at the beginning of the write phase S—e.g., at the points in time t3, t3′, t3″, t3′″ illustrated in FIGS. 3a-3d—by the self repair circuit 7 (or in one embodiment by the above-mentioned further device (or the test device 9, etc.)), and may, for instance, be sent to the above-mentioned memory redundancy area 8 or to a controller controlling same.

The data required for writing the correct test data which are, for instance, sent by the self repair circuit 7 to the memory redundancy area 8 or to the controller controlling same may, in addition to the correct test data (“target data”), for instance, include the address of the redundant memory cell that is to be used instead of the defective memory cell and that is, for instance, arranged in the above-mentioned memory redundancy area 8 (and/or e.g., information that indicates in which of a plurality of different memory redundancy areas the respective redundant memory cell is arranged, etc.).

In reaction to the data received, for instance, from the self repair circuit 7, the—correct—test data (“target data”) are then stored in the redundant memory cell of the memory redundancy area 8 which replaces the defective memory cell, and the corresponding redundant memory cell is thus—at an early point in time (namely already at the points in time t5, t5′, t5″, t5′″ illustrated in FIGS. 3a-3d, i.e. at the end of the write phase S)—initialized.

After the end of the write phase S, i.e. after the points in time t5, t5′, t5″, t5′″ illustrated in FIGS. 3a-3d, a corresponding read access may then be performed to the corresponding redundant memory cell, and the test data (“target data”) read into the redundant memory cell may be read out therefrom again.

From the point in time at which both the above-mentioned write phase S and the above-mentioned reprogramming phase U are finished (e.g., from the point in time t4 in FIG. 3a, from the point in time t5′ in FIG. 3b, from the point in time t7″ in FIG. 3c, from the point in time t5′″ in FIG. 3d, etc.), a read access to the above-mentioned defective memory cell which is initiated by the test device 9 in the above-mentioned manner therefore results in that a corresponding read access is instead performed to the redundant memory cell replacing same, and in that the test data stored therein are read out therefrom and are output at corresponding data input/output pins of the semiconductor memory device 1 (and/or—as explained above—are supplied to the self repair circuit 7 provided on the semiconductor device 1 for test or checking purposes).

Thus—after the detection of an error—the above-mentioned semiconductor device test that is, for instance, performed by the test device 9 may be continued at a substantially earlier time than this is the case with conventional test methods, and/or without a separate, external write access to the redundant memory cell replacing the defective memory cell having to be performed by the test device 9 prior to the continuation of the semiconductor device test for initialization of the above-mentioned redundant memory cell.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for operating a semiconductor memory device comprising at least one memory cell and at least one redundant memory cell comprising:
reading out data written in the memory cell;
determining whether read-out data concur with target data;
reprogramming or reconfiguring, respectively, the semiconductor device, so that the redundant memory cell replaces the memory cell if the read-out data do not concur with the target data; and
writing the target data in the redundant memory cell already during the reprogramming or reconfiguring, respectively.

2. The method of claim 1, comprising starting the writing of the target data in the redundant memory cell simultaneously with or prior to the beginning of the reprogramming.

3. The method of claim 1, comprising starting the writing of the target data in the redundant memory cell directly after the beginning of the reprogramming, less than three or two clocks after the beginning of the reprogramming.

4. The method of claim 1, comprising performing the writing of the target data by a circuit provided on the semiconductor memory device, including a self-repair circuit.

5. The method of claim 4, comprising providing, for writing the target data, read out from a register on the semiconductor memory device.

6. The method of claim 5, comprising wherein the register is part of the self-repair circuit.

7. The method of claim 4, comprising using the self-repair circuit for determining whether the read-out data concur with the target data.

8. The method of claim 1, comprising:
performing the method during a test operation of the semiconductor memory device.

9. A semiconductor memory device comprising:
at least one memory cell;
at least one redundant memory cell,
wherein the semiconductor memory device is configured to be reprogrammed or reconfigured such that the redundant memory cell replaces the memory cell if data read out from the memory cell do not concur with target data; and
wherein the semiconductor memory device comprises a circuit for writing the target data in the redundant memory cell already during the reprogramming or reconfiguring.

10. The semiconductor memory device of claim 9, comprising wherein the circuit is a self repair circuit.

11. The semiconductor memory device of claim 9, comprising a register for storing the target data to be written into the redundant memory cell.

12. The semiconductor memory device of claim 11, comprising wherein the register is part of the self repair circuit.

13. The semiconductor memory device of claim 12, comprising wherein the self repair circuit is designed and equipped such that it compares the target data stored in the register with the data read out from the memory cell.

14. An electronic system comprising:
at least one memory module; and
a memory device including at least one memory cell, and at least one redundant memory cell,
wherein the semiconductor memory device is configured to be reprogrammed or reconfigured such that the redundant memory cell replaces the memory cell if data read out from the memory cell do not concur with target data; and
a device configured for writing the target data in the redundant memory cell already during the reprogramming or reconfiguring.

15. The system of claim 14, comprising:
a controller coupled to the memory device.

16. The system of claim 1, comprising:
wherein the controller is a tester.

17. An integrated circuit comprising:
a memory device including at least one memory cell, and at least one redundant memory cell, wherein the memory device is configured to be reprogrammed or reconfigured such that the redundant memory cell replaces the memory cell if data read out from the memory cell do not concur with target data; and
a circuit configured for writing the target data in the redundant memory cell already during the reprogramming or reconfiguring.

18. The integrated circuit of claim 17, comprising wherein the device is a self repair circuit.

19. The integrated circuit of claim 17, comprising a register for storing the target data to be written into the redundant memory cell.

20. The integrated circuit of claim 19, comprising wherein the register is part of the self repair circuit.

21. The integrated circuit of claim 20, comprising wherein the self repair circuit is designed and equipped such that it compares the target data stored in the register with the data read out from the memory cell.
